(19) United States
(12) Patent Application Publication
(10) Pub. No.: US 2009/0131078 A1
(43) Pub. Date: May 21, 2009

(54) METHOD AND DEVICE FOR ENHANCING POSITIONING OF USER EQUIPMENT

(76) Inventor: Ping Yang, Shenzhen (CN)

Correspondence Address: BRINKS HOFER GILSON & LIONE, P.O. BOX 10395, CHICAGO, IL, 60610, US

(21) Appl. No.: 12/358,906

(22) Filed: Jan. 23, 2009

Related U.S. Application Data
(63) Continuation of application No. PCT/CN2007/070315, filed on Jul. 18, 2007.

(30) Foreign Application Priority Data
Aug. 16, 2006 (CN) 200610062152.X

(51) Int. Cl. H04W 24/00; H04B 1/38

(52) U.S. Cl. 455/456.1; 455/561

(57) ABSTRACT

A method and a device for enhancing positioning of user equipment (UE) are provided. The information about the adjacent cells is sufficiently utilized to determine the coverage area where the UE is located and then a basic positioning method is used based on the determined coverage area. Thus, the positioning precision for cells disposed with repeaters is effectively improved without any additional cost of networks and terminals.

### CROSS-REFERENCE TO RELATED APPLICATIONS

The application is a continuation application of PCT/CN2007/070315, filed on Jul. 18, 2007, which claims priority to Chinese Patent Application No. 200610062152.X, filed on Aug. 16, 2006, and entitled “METHOD, SYSTEM AND RADIO NETWORK CONTROLLER FOR ENHANCING POSITIONING OF USER EQUIPMENT”, both of which are incorporated herein by reference in their entirety.

### FIELD OF THE DISCLOSURE

The present disclosure relates to the field of mobile communication and particularly to a positioning technique in a repeater environment in a mobile communication system. More particularly, the present disclosure relates to a system and a device for enhancing positioning of user equipment (UE).

### BACKGROUND

With the rapid development of the mobile communication industry, various value-added mobile services and mobile data services have been proposed among which the location service (LCS) has been widely accepted by the public and has attracted much attention.

Currently, three mobile positioning techniques have been widely used in the 3rd generation (3G) mobile communication network, namely, the network-based cell identity (Cell ID) technique, the observed time difference of arrival (OTDOA) technique, and the assisted global positioning system (A-GPS) technique. In the OTDOA technique, the positioning is realized by using a UE to measure the relative time of arrival of pilot signals from different base stations (BSs), so that the OTDOA technique is a positioning technique based on a wave transmission time. This technique achieves a high positioning precision but greatly relies on the time reference and is greatly influenced by the multi-path interference. The A-GPS technique is a technique for positioning the UE through combining network BS information with GPS information which may be applied in global system for mobile communications (GSM)/general packet radio service (GPRS), wideband code division multiple access (WCDMA), and code division multiple access 2000 (CDMA 2000) networks. The advantage of the A-GPS solution lies in the positioning precision. In an open area such as an outdoor environment, the A-GPS technique achieves a precision of about 5-10 meters in a normal operating environment of the GPS. Therefore, among all positioning techniques, the A-GPS technique is considered as achieving the highest positioning precision. However, the A-GPS technique has a higher requirement on a mobile phone which increases the cost of the UE. Furthermore, A-GPS technique is restricted by the environment where the UE is located. The cell-based Cell ID technique is the simplest positioning technique which can provide an automatic positioning service to a current mobile subscriber without modifying a mobile phone or a network. This technique determines the position of a subscriber according to a Cell ID of a cell where the UE is located so the positioning precision thereof is determined by the cell radius. Compared with the other techniques, the Cell ID technique requires less investment but provides the lowest positioning precision.

Therefore, an enhanced Cell ID positioning method, that is, cell identity with round trip time (Cell ID+RTT), has been proposed in the prior art, which uses a round trip time (RTT) length of signal transmission between a BS and a terminal to determine a distance from the terminal to the BS. As shown in FIGS. 1 and 2, for a UE in a non-soft handoff region, only the RTT of the BS in communication with the UE can be measured, and a time of arrival (ToA) distance is obtained based on the RTT and a receiving-transmitting (Rx-Tx) time difference of the UE (ToA distance=[(RTT−Rx-Tx Time Difference)/2]×speed of light). Therefore, the positioning scope is only one circle (for an omnidirectional cell) or one arc (for a sector cell). As shown in FIG. 3, for a UE in a soft handoff region, RTTs of a plurality of BSs, for example, a first BS 21, a second BS 22, and a third BS 23 (in activated set) can be measured so that a plurality of ToA distances can be obtained based on the RTTs and the Rx-Tx time difference of the UE, that is, a first ToA distance 10, a second ToA distance 20, and a third ToA distance 30. Thus, a plurality of circles or arcs centered at the BSs can be obtained, and the UE can be specifically positioned according to intersections among the circles or arcs.

In the conventional mobile communication system, repeaters have been widely used to solve the coverage problem. However, the repeaters may severely influence the precision of UE positioning. A donor antenna receives a downlink signal sent by a main BS. Then the downlink signal is amplified and sent to a coverage area of a repeater by a retransmission antenna. An uplink signal from the coverage area of the repeater is received by the retransmission antenna. Then the uplink signal is amplified and sent to an antenna of the main BS via the donor antenna.

Obviously, the repeaters and the corresponding main BS logically belong to the same cell, but their geographical coverage locations and transmission antenna locations are significantly different from each other. Generally, the uplink signals of the repeaters are gathered at an RF end of the main BS and then sent to the BS for processing. Therefore, the BS cannot distinguish the UE is located in the coverage area of which repeater. As for the cell-based positioning mode that has been widely used in the GSM, CDMA, CDMA2000, and WCDMA system, the positioning precision thereof depends on the cell radius. As the repeaters are introduced, the cell radius is not the radius of the cell originally covered by the BS but is determined by a coverage radius of the BS, a distance between the BS and the repeaters, and coverage radii of the repeaters. Therefore, in the environment deployed with repeaters, an equivalent coverage radius of the BS is extended significantly, and the positioning precision of the cell-based positioning mode is deteriorated significantly. As for the positioning mode based on time differences, if it cannot specifically distinguish that the signal received by the UE is sent from which antenna (from antenna of the main BS or the repeaters, and from antenna of which specific repeater), the positioning cannot be implemented even if the time difference information is obtained since the transmission reference cannot be determined.

To ensure the effective positioning of the UE in the coverage areas of repeaters, a mode of combining the repeaters with positioning element (PE) may be used for network layout. However, in order to realize the UE positioning, this solution needs to at least arrange the PE in the coverage area of each repeater which makes the network planning more complicated as well as increases the equipment purchase cost and operation and maintenance cost.

### SUMMARY OF THE DISCLOSURE

A method for enhancing positioning of a UE includes determining whether a cell where the UE is located is deployed with a repeater, obtaining information about adjacent cells from a measurement information about the UE, matching the obtained information about the adjacent cells with a pre-stored network configuration information, wherein the network configuration information comprises information about adjacent cells of the coverage area of main base station (BS) and the coverage area of the repeater, determining a coverage area where the UE is located according to the result of matching, and positioning the UE according to the determined coverage area.

A device for enhancing positioning of a UE includes a positioning unit, an information extracting unit, and a determining unit. The information extracting unit is adapted to query measurement information about the UE and extract information about adjacent cells of the UE if a cell where the UE is located is deployed with a repeater. The determining unit is adapted to match the information about the adjacent cells extracted by the information extracting unit with the network configuration information pre-stored in the storage unit so as to determine a coverage area where the UE is located, wherein the network configuration information comprises information about adjacent cells of the coverage area of main base station (BS) and the coverage area of the repeater. The positioning unit is adapted to position the UE according to the coverage area where the UE is located determined by the determining unit.

The embodiments of the present disclosure make use of the information about the adjacent cells of the UE to determine whether the UE is located in the coverage area of the main BS, a coverage area of a specific repeater, or in an area combination of the coverage area of the main BS and coverage areas of the repeaters. Based on the determined coverage area where the UE is located, a positioning mode of, for example, Cell ID, Cell ID+RTT, or OTDOA can be selected so as to effectively improve the positioning precision in cells deployed with repeaters without modifying the repeaters or adding any additional cost of networks and terminals.

### BRIEF DESCRIPTION OF THE DRAWINGS

The present disclosure will become more fully understood from the detailed description given herein below for illustration only, which thus is not limitative of the present disclosure, and wherein:

FIG. 1 is a schematic structural diagram of an enhanced Cell ID+RTT positioning technique for a non-soft handoff region in a conventional mobile communication system;

FIG. 2 is another schematic structural diagram of an enhanced Cell ID+RTT positioning technique for a non-soft handoff region in the conventional mobile communication system;

FIG. 3 is a schematic structural diagram of an enhanced Cell ID+RTT positioning technique for a soft handoff region in the conventional mobile communication system;

FIG. 4 is a schematic structural diagram of repeater networking in a mobile communication system according to an embodiment of the present disclosure;

FIG. 5 is a schematic flow chart of a method for positioning UE according to an embodiment of the present disclosure; and

FIG. 6 is a block diagram of a structure of a radio network controller according to an embodiment of the present disclosure.

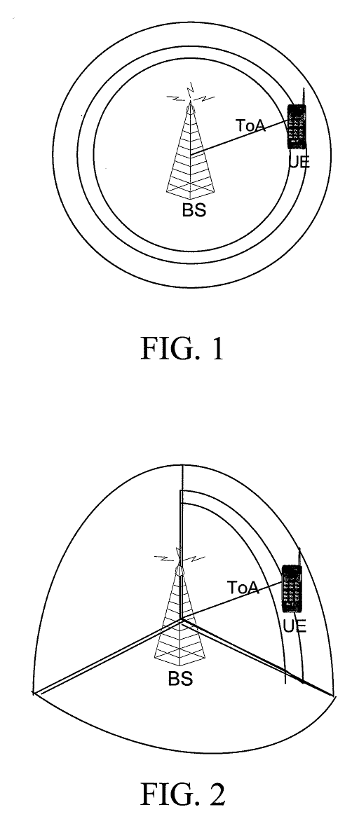

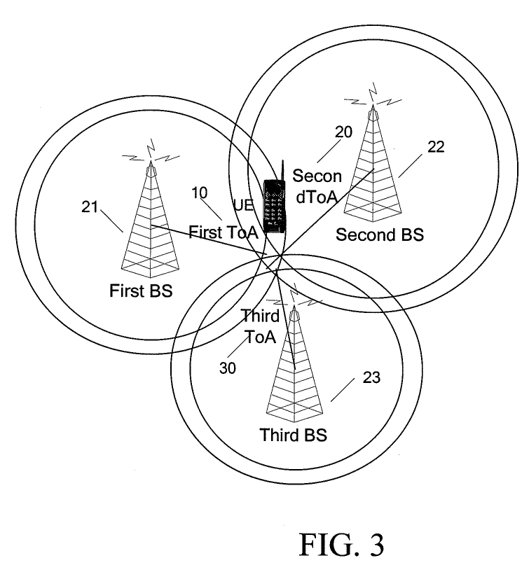

### DETAILED DESCRIPTION OF THE EMBODIMENTS

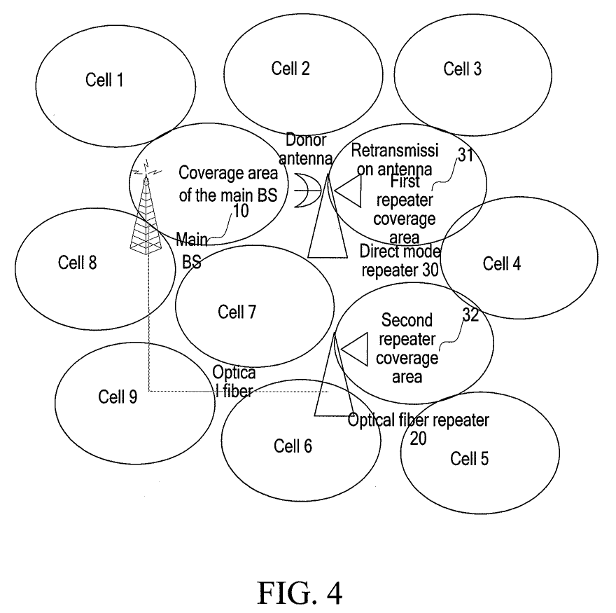

FIG. 4 is a schematic diagram of repeater networking in a mobile communication system according to an embodiment of the present disclosure. FIG. 4 shows two types of repeaters, both of which belong to one embodiment of the present disclosure. The embodiments of the present disclosure are also applicable to many networking modes of other types of repeaters such as frequency selective repeaters, frequency shifting repeaters, and indoor repeaters.

Referring to FIG. 4, a direct mode repeater 30 uses a donor antenna to receive a downlink signal sent from a main BS 10 and uses a retransmission antenna to transmit the signal to cover a first repeater coverage area 31. An uplink signal from the first repeater coverage area 31 is received by the retransmission antenna of the direct mode repeater 30, then transmitted by the donor antenna, and finally received by an antenna of the main BS 10. Similarly, an optical fiber repeater 20 uses optical fibers to carry out signal transmission between the repeater and the main BS 10. The optical fiber repeater 20 covers a second repeater coverage area 32. In FIG. 4, the coverage area of the main BS 10, the first repeater coverage area 31, and the second repeater coverage area 32 have the same Cell ID which belong to the same cell.

After the networking is completed, the neighborhood relations between the coverage area of the main BS 10, the first repeater coverage area 31, and the second repeater coverage area 32 and other surrounding cells are fixed. The adjacent cells of the coverage area of the main BS 10, the first repeater coverage area 31, and the second repeater coverage area 32 are not completely the same. When a UE is located in the coverage area of the main BS and coverage areas of different repeaters, the UE may receive signals from other surrounding cells (adjacent cells) besides the signals from the main BS and repeaters. Under a normal condition, the characteristics of signals sent by the repeaters are identical with that of signals sent by the main BS so that the UE cannot distinguish where the signals are sent from. However, the characteristics of signals from other surrounding cells (adjacent cells) are somewhat different from that of the signals from the main BS and repeater cells (cells deployed with repeaters). The main BS and different repeaters respectively cover different areas. When the UE is located in the coverage area of the main BS or the coverage areas of the repeaters, as the coverage areas belong to the same cell, it cannot be determined whether the signal is sent from the main BS or the repeaters based on the signal from the cell. However, when the UE is located in different areas, the measured signals from adjacent cells (other surrounding cells) are different, and such difference is called an adjacent cell difference of the UE. The neighborhood relations between the main BS, a plurality of repeater coverage areas, and surrounding cells can be obtained through network planning and actual measurements which can be pre-stored in the network, for example, in a radio network controller. Thus, the adjacent cell difference can be used to further determine whether the UE is in the coverage area of the main BS or in a coverage area of a specific repeater.

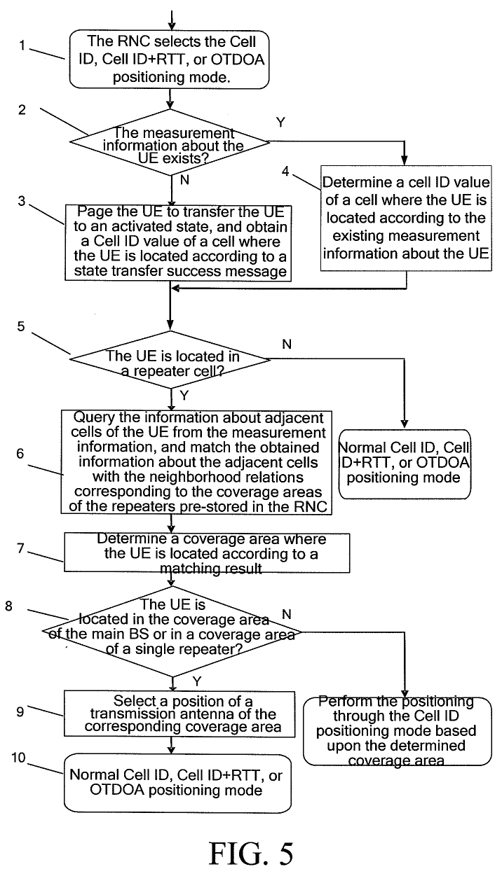

Referring to FIG. 5, a method for enhancing positioning of a UE according to an embodiment of the present disclosure mainly includes the following steps.

In Step 1, upon receiving a positioning request, a radio network controller pre-stored with network configuration information (including information about adjacent cells) about a coverage area of a main BS and coverage areas of repeaters selects a positioning mode according to the positioning request.

The positioning mode includes, but not limited to, Cell ID, Cell ID+RTT, or OTDOA positioning mode. In this embodiment, after the radio network controller receives the positioning request, the radio network controller may select the Cell ID, Cell ID+RTT, or OTDOA positioning mode.

In Step 2, the radio network controller queries whether measurement information about the UE exists or not which is used to determine a cell where the UE is located. If the measurement information about the UE exists, the process proceeds to Step 4. If the measurement information about the UE does not exist, the process proceeds to Step 3.

In Step 3, the radio network controller pages the UE to enable the UE to switch from an idle state (such as a URA_PCH state or IDLE state) to an activated state (such as a Cell_DCH state or Cell_FACH state). After the state of the UE is switched, the UE reports a state switch success message to the radio network controller, enabling the radio network controller to determine the cell where the UE is located according to the cell where the state switch success message is sent from so as to obtain a Cell ID value of the cell where the UE is located.

In Step 4, a Cell ID value of the cell where the UE is located is determined according to the existing measurement information about the UE.

In Step 5, the radio network controller matches the pre-stored network configuration information with the Cell ID information obtained in Step 3 or Step 4 so as to determine whether the cell is a cell deployed with a repeater (a repeater cell) or not. If the cell is a repeater cell, the process proceeds to Step 6. If the cell is not a repeater cell, no special processing is performed, and the positioning is carried out through an existing positioning mode, for example, the Cell ID, Cell ID+RTT, or OTDOA positioning mode.

In Step 6, a measurement information about the UE is queried, and information about adjacent cells of the UE is extracted from the measurement information. The extracted information about the adjacent cells is matched with the information about the adjacent cells corresponding to the coverage area of the main BS and the coverage areas of the repeaters pre-stored in the radio network controller.

In Step 7, it is determined whether the UE is located in the coverage area of the main BS, a coverage area of a specific repeater, or an area combination of the coverage area of the main BS and the coverage areas of the repeaters according to a matching result of Step 6.

In Step 8, after the specific coverage area is determined, if the determined coverage area is only the coverage area of the main BS or a coverage area of a specific repeater, the process proceeds to Step 9. If the determined coverage area includes two or more than two coverage areas of the coverage area of main BS and the coverage area(s) of the repeater(s), the basic Cell ID positioning mode is directly used. For example, a central position of the two or more than two coverage areas is taken as the position of the UE. Here, the central position may be pre-stored or obtained through temporary calculations. The central position may be an overlapping area between the two or more than two areas.

In Step 9, the position of a transmission antenna of the coverage area is determined.

In Step 10, the determined position of the transmission antenna of the coverage area is taken as a position of an antenna of the cell where the UE is located, corresponding sector information is extracted, and then the basic Cell ID, Cell ID+RTT or OTDOA positioning mode is used, which is well known to persons skilled in the art.

As described above, in the method for enhancing the positioning in repeater cells according to the embodiments of the present disclosure, the information about the adjacent cells corresponding to the coverage area of the main BS and the coverage areas of the repeaters is pre-stored in the radio network controller. The information about the adjacent cells of the UE is obtained by using the measurement information about the UE. Then the obtained information about the adjacent cells of the UE is matched with the pre-stored information about the adjacent cells corresponding to the coverage area of the main BS and the coverage areas of the repeaters so as to determine the specific coverage area where the UE is located (the coverage area of the main BS, a coverage area of a specific repeater, or an area combination of the coverage area of the main BS and the coverage areas of repeaters). Furthermore, the central position or the antenna position (including or excluding the sector information) of the determined area is determined according to the determined coverage area where the UE is located. Based on the central position or antenna position, the basic Cell ID, Cell ID+RTT, or OTDOA positioning mode is used to improve the positioning precision.

Persons having ordinary skill in the art will understand that all or a part of the steps in the method according to the above embodiment may be completed by relevant hardware under instructions of a program which may be stored in a computer readable storage medium, for example, ROM/RAM, magnetic disk, and optical disk.

A system for enhancing positioning of a UE is provided according to an embodiment of the present disclosure and includes at least one main BS, repeaters, a UE, and a radio network controller. The radio network controller stores network configuration information about a coverage area of the BS and coverage areas of the repeaters. The network configuration information includes the coverage area of the main BS, the coverage areas of the repeaters, and neighborhood relations between the main BS and repeaters and surrounding cells thereof. The network configuration information can be obtained through network planning combined with actual measurements and can be stored in the radio network controller. Upon receiving a positioning request, the radio network controller extracts the information about the adjacent cells of the UE and matches the extracted information about the adjacent cells with the pre-stored network configuration information so as to determine the specific coverage area where the UE is located. In the communication system, the networking of the repeaters includes direct mode repeaters, frequency selective repeaters, optical fiber repeaters, frequency shifting repeaters, and indoor repeaters.

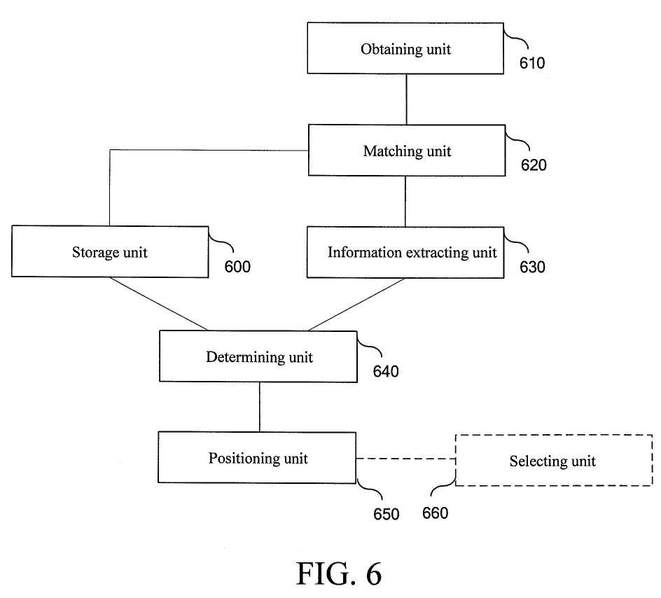

A device for enhancing positioning of a UE is provided according to an embodiment of the present disclosure. As shown in FIG. 6, the device includes a storage unit 600, an obtaining unit 610, a matching unit 620, an information extracting unit 630, a determining unit 640, and a positioning unit 650.

The storage unit 600 is adapted to pre-store network configuration information about a coverage area of a main BS and coverage areas of repeaters.

The obtaining unit 610 is adapted to obtain a Cell ID value of a cell where a UE is located.

The obtaining unit 610 may further include a first obtaining subunit and a second obtaining subunit. The first obtaining subunit is adapted to directly obtain the Cell ID value of the cell where the UE is located when the measurement information about the UE exists. The second obtaining subunit is adapted to page the UE to enable the UE to switch from an idle state to an activated state when the measurement information about the UE does not exist so as to determine the cell where the UE is located according to a cell where a state switch success message reported by the UE is sent from and to extract the cell ID value of the cell.

The matching unit 620 is adapted to match the network configuration information pre-stored in the storage unit 600 with the Cell ID value obtained by the obtaining unit 610.

The information extracting unit 630 is adapted to query measurement information about the UE and extract information about adjacent cells of the UE when the matching unit 620 determines that the cell corresponding to the Cell ID value is deployed with a repeater.

The determining unit 640 is adapted to determine a specific coverage area where the UE is located according to a matching result between the information about the adjacent cells extracted by the information extracting unit 630 and the network configuration information stored in the storage unit 600. If the UE is not located in a repeater cell, the basic Cell ID, Cell ID+RTT, or OTDOA positioning mode is used for positioning. If the UE is located in a repeater cell, the information extracting unit 630 queries information about the adjacent cells of the UE from the measurement information. Then the determining unit 640 determines the specific coverage area where the UE is located according to a matching result between the information about the adjacent cells of the UE extracted by the information extracting unit 630 and the network configuration information stored in the storage unit 600.

The positioning unit 650 is adapted to determine the position of a UE according to the coverage area where the UE is located which is determined by the determining unit 640.

If the determined coverage area where the UE is located is only the coverage area of the main BS or a coverage area of a specific repeater, a position of a transmission antenna of the coverage area is determined, and the UE is positioned according to the position of the transmission antenna.

If the determined coverage area includes two or more than two areas of the coverage area of the main BS and the coverage areas of the repeaters, a central position of the two or more than two coverage areas in the coverage area of the main BS and the coverage areas of the repeaters is determined, and the UE is positioned according to the central position.

Furthermore, based upon the above embodiment, another embodiment of the present disclosure further includes a selecting unit 660 which is adapted to select an optical positioning mode and to provide the optimal positioning mode to the positioning unit 650.

It should be noted that, the device for enhancing positioning of a UE may be corresponding to different devices in specific network systems, for example, a radio network controller in a WCDMA system or a base station controller in a CDMA system.

Preferred embodiments of the present disclosure are illustrated above. However, persons skilled in the art should understand that the present disclosure is not limited to the embodiments illustrated and exemplified herein and may have different forms, implementations, and modifications other than those proposed and illustrated here, and may be implemented through many variations, modifications, and equivalents. Therefore, although the present disclosure is illustrated with reference to the preferred embodiments, the illustrations are merely exemplary and for description purpose, that is, to provide a detailed descriptions of the present disclosure. In view of the foregoing, it is intended that the present disclosure cover modifications and variations provided that they fall within the scope of the following claims and their equivalents.

What is claimed is:

1. A method for enhancing positioning of user equipment (UE), comprising:
determining whether a cell where the UE is located is deployed with a repeater;
obtaining information about adjacent cells from a measurement information about the UE;
matching the obtained information about the adjacent cells with pre-stored network configuration information, wherein the network configuration information comprises information about adjacent cells of a coverage area of a main base station (BS) and a coverage area of the repeater;
determining a coverage area where the UE is located according to the result of matching; and
positioning the UE according to the determined coverage area.

2. The method for enhancing positioning of a UE according to claim 1, wherein the determining whether a cell where the UE is located is deployed with a repeater comprises:
obtaining a cell identity (Cell ID) value of a cell where the UE is located;
matching the obtained Cell ID value with the pre-stored network configuration information about the coverage area of the BS and the coverage area of the repeater; and
determining whether the cell corresponding to the Cell ID value is deployed with the repeater.

3. The method for enhancing positioning of a UE according to claim 1, wherein the determined coverage area where the UE is located is any one of: the coverage area of the main BS, the coverage area of the repeater, and an area combination of the coverage area of the main BS and the coverage area of the repeater.

4. The method for enhancing positioning of a UE according to claim 2, wherein the positioning the UE according to the determined coverage area further comprises:
determining a position of a transmission antenna of the determined coverage area when the determined coverage area is an area of the coverage area of the main BS or the coverage area of the repeater and positioning the UE according to the position of the transmission antenna; or
determining a central position of a plurality of areas of the coverage area of the main BS and the coverage area of the repeater when the determined coverage area comprises a plurality of areas of the coverage area of the main BS and the coverage area of the repeater and positioning the UE according to the central position.

5. The method for enhancing positioning of a UE according to claim 1, wherein the UE is positioned by using a Cell ID positioning mode, a cell identity with round trip time (Cell ID+RTT) positioning mode, or an observed time difference of arrival (OTDOA) positioning mode.

6. The method for enhancing positioning of a UE according to claim 2, wherein the obtaining the Cell ID value of the cell where the UE is located further comprises:
when measurement information about the UE exists, querying the measurement information about the UE and obtaining the Cell ID value of the cell where the UE is located; or
when measurement information about the UE does not exist, paging the UE to enable the UE to switch from an idle state to an activated state and obtaining the Cell ID value of the cell where the UE is located according to a state switch success message reported by the UE.

7. The method for enhancing positioning of a UE according to claim 1, wherein the information about the adjacent cells about the UE is obtained by querying the measurement information of the UE.

8. The method for enhancing positioning of a UE according to claim 1, wherein the network configuration information is pre-stored in a radio network controller or in a base station controller.

9. A device for enhancing positioning of user equipment (UE), comprising:
an information extracting unit adapted to query measurement information about the UE and extract information about adjacent cells of the UE when a cell where the UE is located is deployed with a repeater;
a determining unit adapted to match the information about the adjacent cells extracted by the information extracting unit with network configuration information pre-stored in the storage unit so as to determine a coverage area where the UE is located, wherein the network configuration information comprises information about adjacent cells of a coverage area of main base station (BS) and a coverage area of the repeater; and
a positioning unit adapted to position the UE according to the coverage area where the UE is located determined by the determining unit.

10. The device for enhancing positioning of UE according to claim 9, further comprising:
a storage unit adapted to pre-store network configuration information about the coverage area of the main BS and the coverage area of the repeater;
an obtaining unit adapted to obtain a Cell ID value of the cell where the UE is located; and
a matching unit adapted to match the network configuration information pre-stored in the storage unit with the Cell ID value obtained by the obtaining unit.

11. The device for enhancing positioning of a UE according to claim 9, wherein the coverage area where the UE is located is one of the coverage area of the main BS, the coverage area of the repeater, and an area combination of the coverage area of the main BS and the coverage area of the repeater.

12. The device for enhancing positioning of a UE according to claim 9, wherein the positioning unit is further adapted to determine a position of a transmission antenna of the determined coverage area when the determined coverage area is an area of the coverage area of the main BS or the coverage area of the repeater and position the UE according to the position of the transmission antenna; or
the positioning unit is further adapted to determine a central position of a plurality of areas of the coverage area of the main BS and the coverage area of the repeater when the determined coverage area comprises the plurality of areas of the coverage area of the main BS and the coverage area of the repeater and position the UE according to the central position.

13. The device for enhancing positioning of a UE according to claim 9, further comprising:
a selecting unit adapted to select a Cell ID positioning mode, a Cell ID+RTT positioning mode, or an OTDOA positioning mode and provide the selected positioning mode to the positioning unit.

14. The device for enhancing positioning of a UE according to claim 10, wherein the obtaining unit further comprises:
a first obtaining subunit adapted to query measurement information about the UE and obtain the Cell ID value of the cell where the UE is located when the measurement information about the UE exists; and
a second obtaining subunit adapted to page the UE to enable the UE to switch from an idle state to an activated state when the measurement information about the UE does not exist and obtain the Cell ID value of the cell where the UE is located according to a state switch success message reported by the UE.

15. The device for enhancing positioning of a UE according to claim 9, wherein the device is a radio network controller or a base station controller.

16. A system for enhancing positioning of a UE, comprising:
a main base station (BS);
a repeater; and
a device,
wherein the device is adapted to store network configuration information, extract information about adjacent cells from a measurement information about the UE, and match the extracted information about the adjacent cells with pre-stored network configuration information so as to determine a specific coverage area where the UE is located, wherein the network configuration information comprises a coverage area of the main BS, a coverage area of the repeater, and neighborhood relations between the main BS and repeaters and surrounding cells.

17. The system for enhancing positioning of a UE according to claim 16, wherein networking of the repeater comprises direct mode repeater, frequency selective repeater, optical fiber repeater, frequency shifting repeater, and indoor repeater.
